(19) United States
(12) Patent Application Publication
(10) Pub. No.: US 2009/0268436 A1
(43) Pub. Date: Oct. 29, 2009

(54) Small scale illumination device

(76) Inventor: Keiji Taiga, Tokyo (JP)

Correspondence Address: ROSENBERG, KLEIN & LEE, 3458 ELLICOTT CENTER DRIVE-SUITE 101, ELLICOTT CITY, MD, 21043, US

(21) Appl. No.: 12/314,347

(22) Filed: Dec. 9, 2008

(30) Foreign Application Priority Data
Apr. 25, 2008 (JP) JP2008-1115035

(51) Int. Cl. F21L 4/00

(52) U.S. Cl. 362/158

(57) ABSTRACT

A small scale illumination device includes a case and at least one battery and a circuit board are located in the case. A Light Emitting Diode is connected to the circuit board and controlled by two press-switches on the circuit board. A cap is connected to the base and protrudes from an opening of the case. The cap includes a transparent dome portion and a flange extending from a lower portion of the dome portion. The flange is connected to the circuit board and can be moved when the user pushes the dome portion to activate either one of the press-switches. A base made by water-proof material is mounted to the case and the cap and two connection members are connected to the base so as to be connected to objects such as bicycle frame.

### FIELD OF THE INVENTION

The present invention relates to an illumination device, and more particularly, to a small scale illumination device which is easily operated and includes less number of parts.

### BACKGROUND OF THE INVENTION

A conventional illumination device except for flashlight, is used on head light for bicycles, tracking units, and diving or climbing equipments. These conventional illumination devices are required to be portable, easily operated and water proof.

The light bulbs of the conventional illumination devices include filaments which consume significant energy and are powered by batteries which occupy large space so that the illumination devices are difficult to meet requirements of the users.

Light Emitting Diodes (LEDs) are small in size and light in weight so that LEDs are used widely to be the illumination devices. Generally, the conventional illumination devices include a case with a transparent front end and a threaded rear end, wherein the LEDs are installed in the front end of the case and a battery is located in the case. A circuit is installed within the case and in contact with the battery, A press-switch is installed to the case so as to activate the LEDs.

However, the battery such as the conventional alkaline battery and the NIMH battery requires a certain space which cannot be minimized to a satisfied scale and an extra arrangement is needed to position the battery, and the extra arrangement restricts the application of the illumination devices.

The conventional illumination device has a switch on a side thereof so that the user can access the switch and press the switch. Therefore, how to position the switch is a crucial problem when using the conventional illumination device. Besides, the feature of water proof is also an import factor affecting the design of the conventional illumination device and the satisfaction to the users.

The present invention intends to provide a small scale of illumination device which is modularized, easily manufactured, light in weight and water-proofed. The small scale of the illumination device of the present invention can easily be used with different shapes of objects such as bicycles, helmets and canes.

### SUMMARY OF THE INVENTION

The present invention relates to an illumination device which comprises a cylindrical case including an opening defined centrally therethrough and at least one battery and a circuit board are located in the case. A Light Emitting Diode is connected to the circuit board and controlled by two press-switches. A cap is connected to the base and protrudes from the opening. The cap includes a transparent dome portion and a flange extending from a lower portion of the dome portion. The flange is connected to the circuit board. A base made by water-proof material and mounted to the case and the cap. When pushing the dome portion of the cap, the flange is lowered to activate the press-switches to turn the Light Emitting Diode on or off.

The primary object of the present invention is to provide a small scale illumination device which includes two loop-shaped connection members so as to be easily connected to objects.

Another object of the present invention is to provide a small scale illumination device wherein the Light Emitting Diode is activated by directly pushing the cap so that there will not be necessary to install a switch at the outside of the illumination device.

Yet another object of the present invention is to provide a small scale illumination device which is small and light enough to be convenient for carry.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the illumination device of the present invention;

FIG. 2 is a perspective view to show the illumination device of the present invention;

FIG. 3 is a perspective view to show that the illumination device of the present invention is connected to an object by a hooking member;

FIG. 4 shows a top view of the circuit board of the illumination device of the present invention;

FIG. 5 is a cross sectional view to show the circuit board and the cap of the illumination device of the present invention;

FIG. 6 shows that the illumination device of the present invention is to be connected to an object;

FIG. 7 shows that one of the two connection members of the illumination device of the present invention is mounted to the object;

FIG. 8 shows that the two connection members of the illumination device of the present invention are mounted to the object;

FIG. 9 shows that the two connection members of the illumination device of the present invention are arranged to securely grasp the object;

FIG. 10 shows that a resilient band is connected between the two connection members of the illumination device of the present invention, and

FIG. 11 shows that a user wraps the resilient band of FIG. 10 to his head.

### DETAILED DESCRIPTION OF THE PREFERRED EMBODIMENT

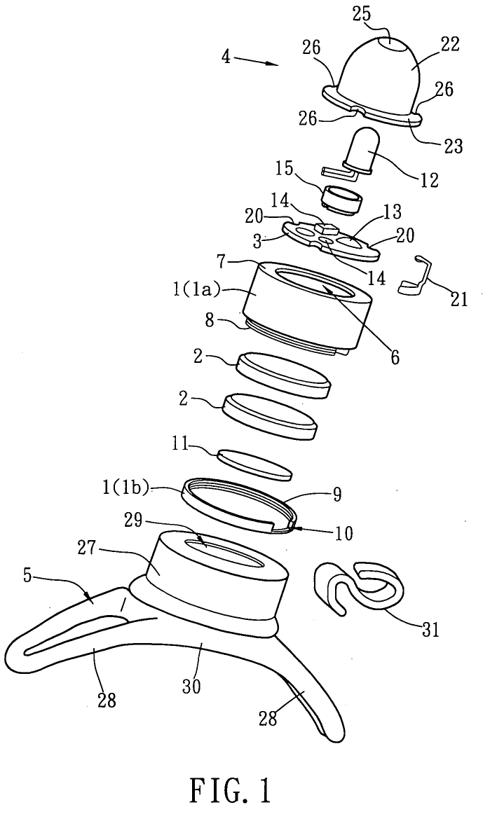

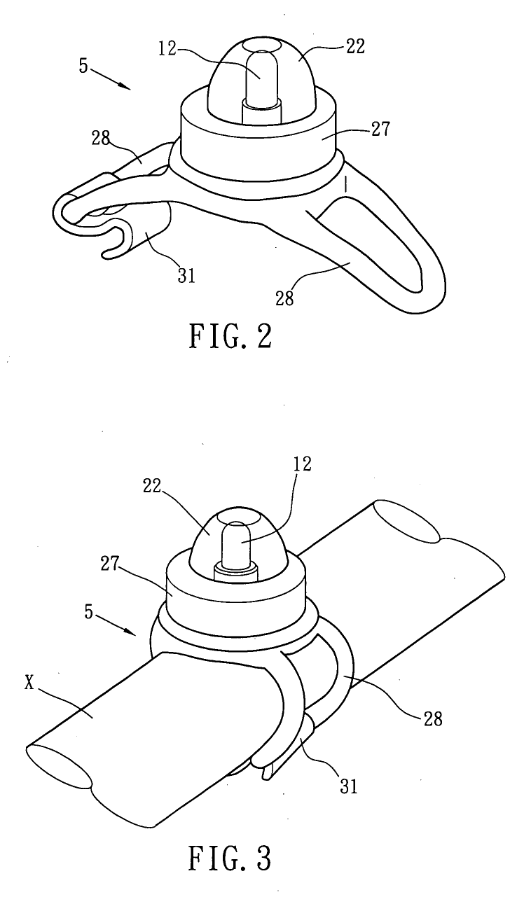

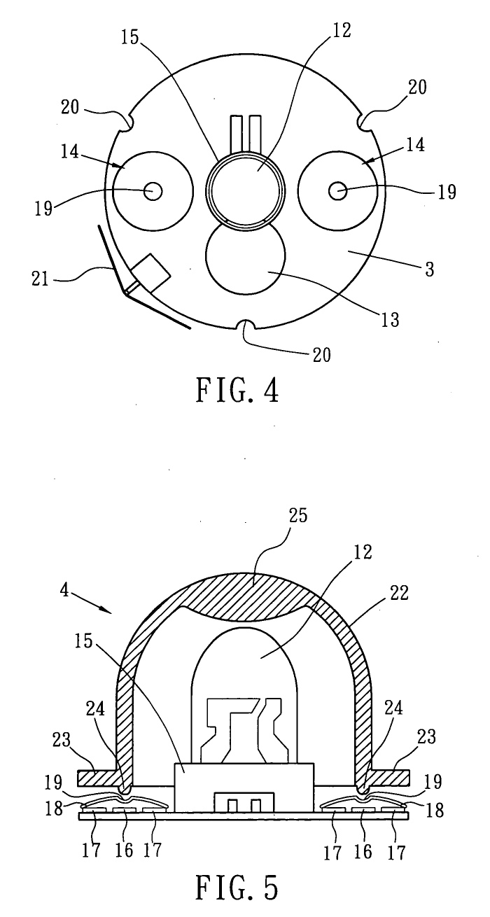

Referring to FIGS. 1, 2, 4 and 5, the illumination device of the present invention comprises a cylindrical case 1, two batteries 2, a circuit board 3, a cap 4 and a base 5.

The case 1 includes an opening 6 defined centrally therethrough and the two batteries 2 and the circuit board 3 are located in the case 1. The case 1 includes a body 1a and a ring 1b which is connected to a lower end of the body 1a. The body 1a includes a top surface 7 around the opening 6 and a groove 8 is defined in an outer periphery of the lower portion of the body 1a. The ring 1b includes a ridge 9 which is slidably engaged with the groove 8 so as to be connected to the body 1a. The ring 1b includes a notch 10 defined in a top thereof so that the user can separate the body 1a and the ring 1b by inserting into the notch 10. The two batteries 2 are two disk-like batteries and the circuit board 3 is a disk-like circuit board. The two batteries 2 are connected in series. A negative end of the batteries 2 is in contact with a contact plate 21 connected to the circuit board 3 and a positive end of the batteries 2 are in contact with the ring 1b. A resilient plate 11 is located at the second end of the batteries 2 so as to absorb shocks. The circuit board 3 includes multiple notches 20 defined in an outer periphery thereof and the body 1a includes multiple bosses (not shown) which are engaged with the notches 20 to restrict the circuit board 3 from rotating.

The case 1 is made by any material that is light and the body 1a can be made by resin, metal or even wood. Preferably, synthetic resin such as polyethylene, epoxide resin, non-statuary polyester fiber resin, silicone resin, thermo-setting resin, polycarbonate, polyethylene terephthalate, polybutylene terephthalate, polyphenylene sulfide, polyphenylene oxide, polyant rate, polysulfone, polyamide imido or polyimide. The ring 1b can be made by soft material so as to be easily separated from the body 1a. The case 1 can also be made by aluminum alloy, copper alloy, steel, stainless steel or iron.

A Light Emitting Diode 12 is connected to the circuit board 3 and controlled by two press-switches 14 on the circuit board 3, wherein the two press-switches 14 are located in opposite diametrically. Each of the two press-switches 14 includes a central contact point 16 and a peripheral contact point 17. A tubular support 15 encloses the light Emitting Diode 12 which can be any available type or color. A flexible plate 18 is made by metal and mounted on each of the press-switches 14. The periphery of the flexible plate 18 contacts the peripheral point 17 and each of the flexible plate 18 includes a recess 19 defined in a top thereof. The circuit board 3 includes a control part 13 which include necessary circuits, resistances, capacitors and ICs so as to control the way that the Light Emitting Diode 12 performs.

A cap 4 is made by resilient silicone rubber and connected to the base 1. The cap 4 includes a transparent dome portion 22 and a flange 23 extending from a lower portion of the dome portion 22. The dome portion 22 is inserted into the case 1 from the lower end thereof and protrudes from the opening 6. The flange 23 is connected to the circuit board 3 and includes a protrusion 24 which is located above the recesses 19. A convex lens 25 is located at the center of the top of the dome portion 22. The flange 23 further includes multiple notches 26 and the body 1a includes multiple bosses (not shown) which are engaged with the notches 26 to restrict the cap 10 from rotating.

The cap 4 can be made by transparent glass synthetic resin such as acrylic resin, acrylic, acrylonitrile, polyurethane, polyvinyl chloride, polystyrene, polyacrylonitrile, polyamide or poly-methyl methacrylate.

A base 5 is made by water-proof material and mounted to the case 1 and the cap 4. Two connection members 28 are connected to a lower portion of the base 5. The base 5 includes a tubular water-proof portion 27 which is located on a bottom 30 which has sufficient thickness. The water-proof portion 27 has a hole 29 defined in a top thereof and the case 1 is located in the water-proof portion 27 via the hole 29 and the cap 4 protrudes from the hole 29. An S-shaped hooking member 31 has one end hooked to one of the connection members 28 and the other end of the S-shaped hooking member 31 is hooked to the other connection member 28.

The base 5 is made by resilient material such as rubber, thermo-elastic rubber, polyyne, styrene butadiene rubber copolymer, acrylonitrile butadiene copolymer, ethylene propylene diene copolymer, ethylene propylene copolymer, polychlor, iso-prene, silicone rubber, urethane, amide, or fluorine. The thick bottom 30 keeps the water-proof portion 27 to have satisfied water-proof feature when it is bent.

The illumination device of the present invention is modularized, easily manufactured, convenient for carry, light in weight and water-proofed.

When using the illumination device, as shown in FIG. 3, the two connection members 28 warp around the object “X” and the hooking member 31 is connected between the two connection members 28 to tightly wrap the object “X”. The object “X” can be a bicycle frame, cane or even the users' finger or wrist.

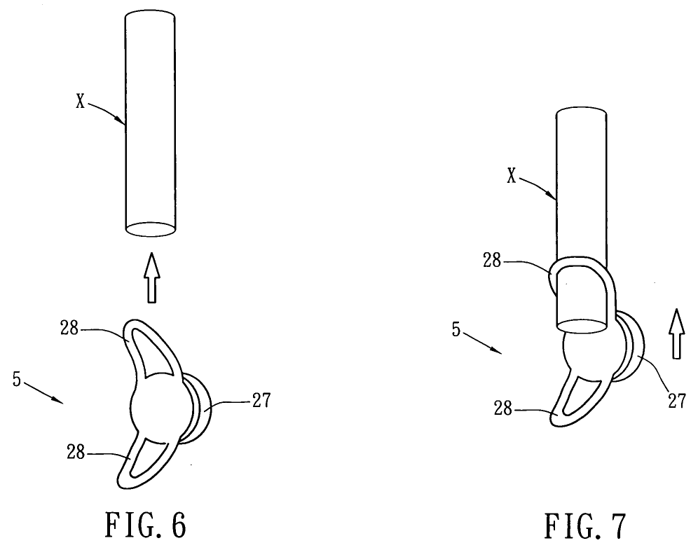

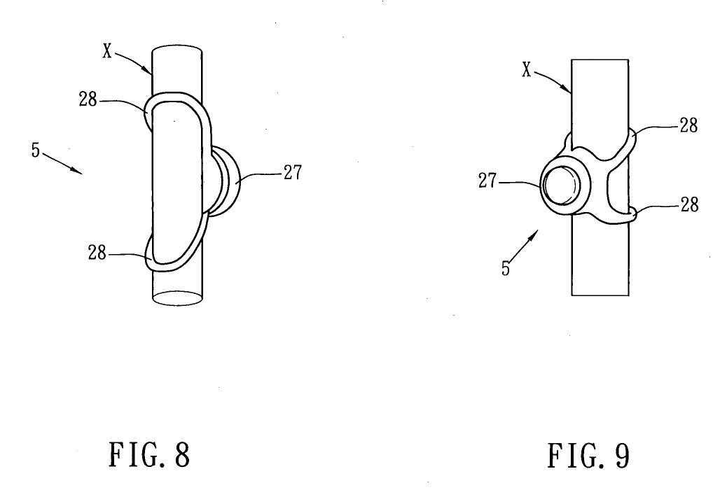

As shown in FIGS. 6 to 9, the illumination device can also be used without using the hooking member 31, the two loop-shaped connection members 28 are mounted to the object “X” if the diameter of the object “X” is smaller than the object “X” disclosed in FIG. 3.

Further referring to FIG. 3, the user simply pushes the dome portion 22 of the cap 4, the dome portion 22 together with the flange 23 are lowered so that the protrusion 24 is lowered to be engaged with the recesses 19 of the flexible plates 18 and the flexible plates 18 are deformed to contact the central contact points 16 so as to activate the Light Emitting Diode 12. When the flexible plates 18 are deformed, a sound is generated by the deformation so that the user is acknowledged the action is completed. When releasing the dome portion 22, the flexible plates 18 bounce back and are separated from the central contact portions 16, so that the Light Emitting Diode 12 is in off status.

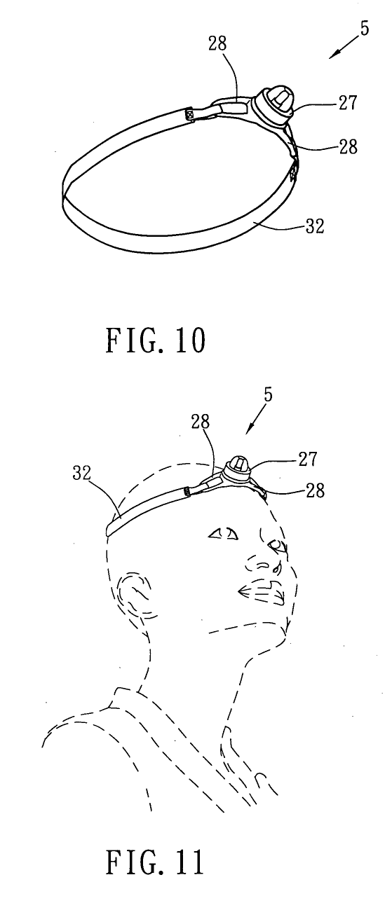

FIGS. 10 and 11 show that the illumination device can be cooperated with a resilient band 32 which is connected between the two connection members 28, the resilient band 32 can be mounted to the user's head or helmet.

The illumination device can be easily mounted to an object by using the two connection members 28 and/or a hooking member 31. The illumination device can also be cooperated with a resilient band 32 to be mounted to a larger object. The illumination device uses disk-like batteries 2 so that the illumination device is small and does not need a switch located on outside of the device. The press-switches 14 can directly activated by pushing the dome portion 22 of the cap 4. This is convenient for the users to operate, especially for the riders to turn the illumination device on or off during riding bicycles. The base 5 is made by resilient material and only the dome portion 22 of the cap 4 protrudes from the base 5 so that the illumination device has satisfied water-proof feature. No extra water-proof device is needed. When the dome portion 22 is pushed, either one of the two press-switches 14 can be activated to activate the Light Emitting Diode 12. The recess 19 of each of the flexible plates 18 ensures that the protrusion 24 can firmly push the flexible plates 18 and the sound that the flexible plates 18 generate help the users to know the action is correctly operated.

While we have shown and described the embodiment in accordance with the present invention, it should be clear to those skilled in the art that further embodiments may be made without departing from the scope of the present invention.

What is claimed is:

1. An illumination device comprising:
a case being a cylindrical case and including an opening defined centrally therethrough;
at least one battery located in the case;
a circuit board being a disk-like circuit board and located in the case, a Light Emitting Diode connected to the circuit board and controlled by two press-switches;
a cap connected to the base and protruding from the opening, the cap including a transparent dome portion and a flange extending from a lower portion of the dome portion, the flange connected to the circuit board, and
a base made by water-proof material and mounted to the case and the cap.

2. The illumination device as claimed in claim 1, wherein the two press-switches are located on the circuit board and in opposite diametrically.

3. The illumination device as claimed in claim 1, wherein each of the two press-switches includes a central contact point and a peripheral contact point, a flexible plate is made by metal and mounted on each of the press-switches and contacts the peripheral point, the flexible plate is pressed and deformed to contact the central contact point.

4. The illumination device as claimed in claim 3, wherein each of the flexible plate includes a recess defined in a top thereof and the flange of the cap includes a protrusion which is located above the recesses.

5. The illumination device as claimed in claim 1, wherein the at least one battery is a disk-like battery.

6. The illumination device as claimed in claim 1, wherein the base is made by flexible silicone rubber.

7. The illumination device as claimed in claim 1, wherein the base includes two connection members connected to a lower portion thereof.

8. The illumination device as claimed in claim 7, wherein a hooking member is connected to one of the two connection members and the hooking member is an S-shaped member.

9. The illumination device as claimed in claim 7, wherein a resilient band is connected between the two connection members.

10. The illumination device as claimed in claim 7, wherein each of the two connection members is a loop-shaped member.
